(19) United States
(12) Patent Application Publication
(10) Pub. No.: US 2004/0268040 A1
(43) Pub. Date: Dec. 30, 2004

(54) External storage device

(75) Inventors: Jae-Ryong Bum, Seoul (KR); Tae-Woo Lee, Seoul (KR); Myung-Seok Kim, Seoul (KR)

Correspondence Address: GREENBLUM & BERNSTEIN, P.L.C., 1950 ROLAND CLARKE PLACE, RESTON, VA, 20191, US

(73) Assignee: Nextway Co. Ltd., Seoul City (KR)

(21) Appl. No.: 10/640,270

(22) Filed: Aug. 14, 2003

(30) Foreign Application Priority Data
Jun. 3, 2003 (KR) 10-2003-35689

(51) Int. Cl. G06F 12/00

(52) U.S. Cl. 711/115

(57) ABSTRACT

Disclosed herein is an external storage device. The external storage device includes a non-volatile storage medium for storing digital data, a Universal Serial Bus (USB) port for providing an interface with an external apparatus, and an expansion slot for accommodating a conventional memory module. The external storage device provides access channels complying with USB Mass Storage Class (MSC) specifications so that the external apparatus accesses the non-volatile storage medium and the memory module, inserted into the expansion slot, through the USB port. When the external storage device receives a medium access command from the external apparatus through the USB port, the external storage device determines whether the medium access command aims to access the non-volatile storage medium or the memory module inserted into the expansion slot by interpreting the medium access command, and provides an access service corresponding to the medium access command.

### BACKGROUND OF THE INVENTION

1. Field of the Invention

The present invention relates generally to an external storage device having a flash memory or hard disk therein, providing a storage space through a digital interface, such as a universal serial bus, and being provided with a memory card slot so that storage capacity is easily expanded and a memory card is also conveniently used. Further, the external storage device of the present invention performs a security process in writing or reading files so as to protect copyrights.

2. Description of the Related Art

Various forms of external storage devices, including an external hard disk, have been used. Recently, external storage devices using flash memories, such as a flash disk and a cell disk, are widely used because of the advantages in which they can be both miniaturized and fabricated at low cost. However, once such external storage devices are fabricated, they are inconvenient in that the expansion of the storage capacity is practically impossible.

Meanwhile, as digital apparatuses, such as a digital camera and a digital camcorder, are popularized, various memory cards, such as a (mini) MultiMedia Card (MMC), a Secure Digital (SD) card and a (mini) memory stick, are widely used. For this purpose, some notebook computers are provided with card slots to support such memory cards. However, since a computer field is not fully oriented to such storage media, there occur inconveniences in which exclusive card readers must be additionally purchased and mounted on computer systems.

Further, after multimedia files are written in external storage devices using flash memories or hard disks, these external storage devices can be used for the purpose of reproducing these multimedia files in a Personal Computer (PC) or an external player. In this case, the illegal copy of multimedia files is problematic. In more detail, Windows Media Audio (WMA) files and Moving Picture Experts Group (MPEG)-1 Audio Layer-3 (MP3) files extracted from a Compact Disc (CD) or multimedia files purchased via the Internet may involve copyrights. If such multimedia files can be copied without any restriction, it is impossible to effectively protect the copyrights in the multimedia files. Accordingly, it is required that a multimedia file is allowed to be copied from a computer system to an external storage device one time, but prohibited from being copied from the external storage device to the computer system or is exceptionally copied only when permission is granted.

### SUMMARY OF THE INVENTION

Accordingly, the present invention has been made keeping in mind the above problems occurring in the prior art, and an object of the present invention is to provide an external storage device having a flash memory or hard disk therein and providing a storage space through a digital interface, such as a universal serial bus, which is provided with a memory card slot so that storage capacity is not only easily expanded but a memory card is also conveniently used, and which performs a certain security process in writing or reading files so as to protect copyrights.

In order to accomplish the above object, the present invention provides an external storage device, including a non-volatile storage medium for storing digital data; a Universal Serial Bus (USB) port for providing an interface with an external apparatus; and an expansion slot for accommodating a conventional memory module; wherein the external storage device provides access channels complying with USB Mass Storage Class (MSC) specifications so that the external apparatus accesses the non-volatile storage medium and the memory module, inserted into the expansion slot, through the USB port; wherein, when the external storage device receives a medium access command from the external apparatus through the USB port, the external storage device determines whether the medium access command aims to access the non-volatile storage medium or the memory module inserted into the expansion slot by interpreting the medium access command, and provides an access service corresponding to the medium access command.

In addition, the present invention provides an external storage device, including a non-volatile storage medium for storing digital data; and a digital interface port for providing an interface with an external apparatus; wherein the external storage device provides an access channel so that the external apparatus accesses the non-volatile storage medium through the digital interface port according to a certain medium access protocol; wherein, when the external storage device receives a file write command from the external apparatus according to the medium access protocol, the external storage device performs a secure file write process, the secure file write process comprising the first step of allocating a space to a file and writing the file on the allocated space and the second step of setting a value of file management information to a second value different from a first value corresponding to information of a physical location where the file is actually written, the second value being obtained by applying a certain rule to the first value.

In addition, the present invention provides an external storage device, including a non-volatile storage medium for storing digital data; and a digital interface port for providing an interface with an external apparatus; wherein the external storage device provides an access channel so that the external apparatus accesses the non-volatile storage medium through the digital interface port in accordance with a certain medium access protocol; wherein, when the external storage device receives a file read command from the external apparatus according to the medium access protocol, the external storage device performs a secure file read process, the secure file read process comprising the first step of obtaining physical information of the file from file management information corresponding to the file and the second step of obtaining data from a second location of the non-volatile storage medium different from a first location of the non-volatile storage medium corresponding to the physical information and transmitting the data through the digital interface port, the second location being obtained by applying a certain rule to the first location.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing the appearance of an external storage device in accordance with an embodiment of the present invention;

FIGS. 2A and 2B are diagrams illustrating the concept of a security process in file exchange between the external storage device and an external computer system;

FIG. 3 is a schematic diagram showing the internal configuration of the external storage device in accordance with an embodiment of the present invention;

FIG. 4 is a diagram showing a 16-bit FAT that is employed in the security process of the external storage device in accordance with an embodiment of the present invention;

FIG. 5 is a diagram the state in which memory cards of different specifications are inserted into a card slot one at a time in the external storage device of the present invention; and

FIG. 6 is a schematic diagram showing the internal configuration of an external storage device in accordance with another embodiment of the present invention.

### DESCRIPTION OF THE PREFERRED EMBODIMENTS

Reference now should be made to the drawings, in which the same reference numerals are used throughout the different drawings to designate the same or similar components.

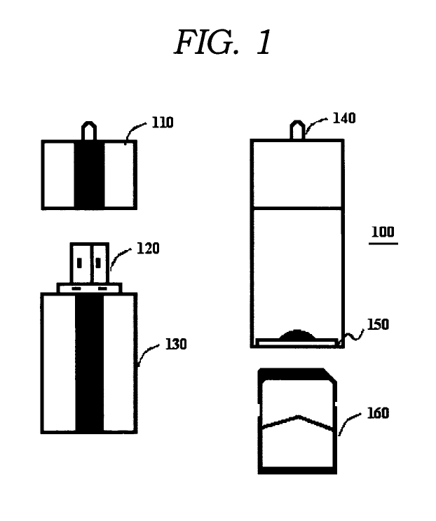

FIG. 1 is a schematic diagram showing the appearance of an external storage device 100 in accordance with an embodiment of the present invention. As shown in this drawing, the external storage device 100 of the present invention is provided with a USB connector 120 on one side of a body 130, which is presented as an example of a digital interface that allows the external storage device 100 to connect with a host system, such as an external host system, and exchange data therewith. Such a connector is not limited to a male type, and can implemented in a female type. The external storage device 100 is further provided with a cap 110 for protecting the USB connector 120, and a ring 140 for facilitating the carrying of the external storage device 100, which are virtually the same as a conventional one.

The external storage device 100 of the present invention is further provided with a card slot 150 for accommodating, in particular, a memory card 160, through which the storage capacity of the external storage device 100 can be expanded. The memory card 160 that can be employed in the present invention is not limited to a specific memory card, such as a MMC, SD card or (mini) memory stick, but may be any memory card. Further, it should be appreciated that the memory card 160 is not limited to memory cards known at the time when the present invention is filed but may be any card available at the time when the external storage device 100 of the present invention is implemented. Further, as described later, the “memory card” and the “card slot” are given as an embodiment, which can be generalized as a “memory module/storage module” and an “expansion slot”, respectively, and should be understood as a module and adapter for expanding a storage space, respectively.

As shown in FIG. 1, the card slot 150 into which the memory card 160 is inserted is preferably formed on the side of the body 130 opposite to the side of the body 130 on which the USB connector 120 is formed. The reason for this is to improve the convenience of use and minimize the size of the external storage device 100.

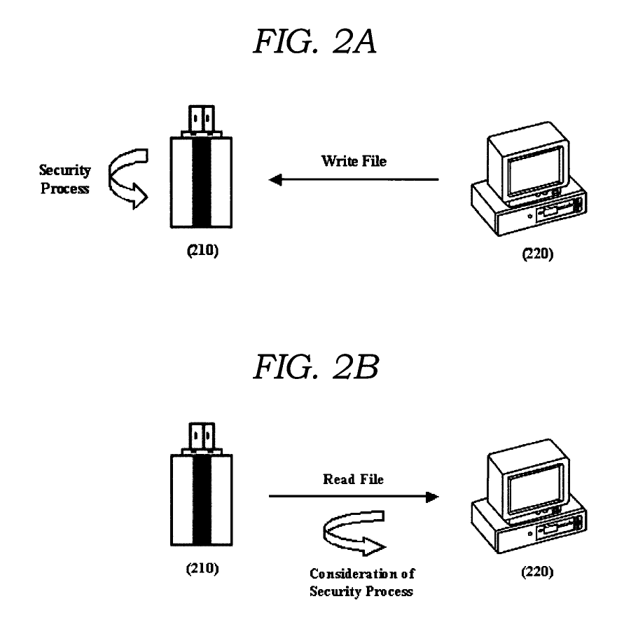

FIGS. 2A and 2B are diagrams illustrating the concept of a security process in file exchange between the external storage device 210 and an external computer system 220. As described above, the external storage device 210 can exchange data with an external computer system 210 through a digital interface in accordance with a certain medium access protocol. In the case where the digital interface is formed of a USB, the medium access protocol is precisely defined in the USB Mass Storage Class specifications. It is assumed that such a protocol is defined or a unique protocol is provided with respect to each of digital interfaces. If such a medium access protocol is not provided, the digital interface cannot be used for such a purpose.

The external storage device 210 and the computer system 220 exchange data or files through such a medium access protocol. In the past, there was no specific restriction on the process in which the computer system 220 writes and reads files. Of course, there was proposed a scheme in which a storage device was provided with a lock key to prohibit the change of contents written in a storage medium overall. The security process dealt with in the present invention has a considerably higher level compared with the prior art lock function.

In the security process dealt with in the present invention, any specific restriction is not put on the process in which the computer system 220 writes data or files on the external storage device 210. Instead, when a file is read from the external storage device 210, for example, the file is copied from the external storage device 210, a restriction is put, which is important in terms of the prohibition of illegal copy. By this, the limitless reproduction of files through the medium of the external storage device 210 can be prevented.

For that purpose, if a file write command in accordance with the medium access protocol is transmitted from the computer system 220, the external storage device 210 of the present invention writes the file while performing the security process. This security process is performed by concealing a physical location where file data is actually written on a storage medium. For example, when a file “a” is written from an address 0xFF0000A0, it is recorded on a corresponding field (cluster field) of a File Allocation Table (FAT) that the file “a” is written from a different address 0xFFEA00A0. In this case, it is impossible for a general computer system to read or copy a corresponding file. It is only possible for a specially authorized apparatus to read or copy the corresponding file.

FIG. 2A is a diagram illustrating a process of the computer system 220 writing a file in an external storage device 210. The external storage device 210 performs a certain security process when the external storage device 210 writes a file. FIG. 2A is a diagram showing a process of the computer system 220 reading a file from the external storage device 210. In order to read a secured file, the computer system 220 should perform a read operation with the security process applied to the file being taken into account. For example, although the contents of the FAT corresponding to the file “a” indicate that the start address of a file data is 0xFFEA00A0, the computer system must understand from the value of the contents that the correct start address is not 0xFFEA00A0but 0xFF0000A0.

In such a security process, since a genuine value (that is, 0xFF0000A0) must be induced from a disguised value (that is, 0xFFEA00A0) at the time of reading a file, a conversion rule must be a “one-to-one function” or a function having its inverse function”.

Meanwhile, such a security process can be implemented in “a file reading process,” somewhat differently from that shown in FIGS. 2A and 2B. That is, the external storage device 210 does not perform a specific security process when the computer system 220 writes a file “a” in the external storage device 210, while the external storage device 210 of the present invention performs a security process similar to the above-described one when the computer system 220 reads the file “a” from the external storage device 210.

For example, when a file “a” is written on the storage medium (starting address of 0xFF0000A0), it is recorded in file management information, such as FAT, that the start address of the file “a” is 0xFF0000A0, which is the same value of the actual starting address. Afterwards, when a command to read the file “a” is transmitted to the external storage device 210 with the start address of 0xFF0000A0, the external storage device 210 returns data from a different address, for example, 0xFF8800A0. In this example, the file “a” can be correctly read, only when the computer system 220 transmits a command to read the file “a” from the external storage device 210, with the start address of a value, e.g., 0xFFFF00A0, which is different from the value in the file management information, that is, 0xFF0000A0.

Even in the case where such a security process is employed, since the computer system 220 must induce a genuine value (that is, 0xFFFF00A0) from a false value (that is, 0xFF0000A0) recorded in the file management information, such as the FAT, at the time of reading the file “a,” the conversion rule of the security process must be a “one-to-one function” and a “function having its inverse function,” as described with respect to the former case.

The above-described two security processes are compared with each other below. In the security process of disguising file management information in the process of writing a file, since contents recorded in the storage medium has already been changed, this security process can be applied to the flash memory contained in the external storage device and the memory card 160 inserted into the card slot 150. In contrast, in the security process of changing a medium access address in the process of reading a file, since contents recorded in the storage medium has not been changed, the file can be read by some other apparatus without hindrance. Therefore, this security process can be applied to the flash memory that is actually integrated with the external storage device 210, but cannot be applied to the memory card 160 inserted into the card slot 150.

In the meantime, since such a security process aims to fulfill a special purpose, such as copyright protection, it may not be adequate to apply the above-descried security processes to all files exchanged between the computer system 220 and the external storage device 210. Another embodiment is described below. Various file formats allow a certain region of a file to be used as a field for indicating a file format or attribute, or have structures for allowing such information to be ascertained therefrom. In this embodiment, when the file is transmitted to the external storage device 210, the external storage device 210 of the present invention can determine whether the security process is required based upon the file formats. With this, when a file write command is transmitted to the external storage device 210, the external storage device 210 can determine whether the security process is required based upon a file extension.

Next, a method of the external storage device 210 or computer system 220 determining whether the security process is required for a written specific file in the process of reading the specific file is described. As described above, when the specific file is written in the external storage device 210, it is determined whether the security process is required for the specific file. At this time, the external storage device 210 can construct file management information corresponding to the specific file according to the security process. Accordingly, in the process of reading a file, it can be determined whether the above-described security process is required for the file by examining how the value of file management information is constructed. Although it is possible to determine whether the above-described security process is required for the file based upon the file extension of the file in the process of reading the file, it is more secure to determine it based upon the value of the file management information.

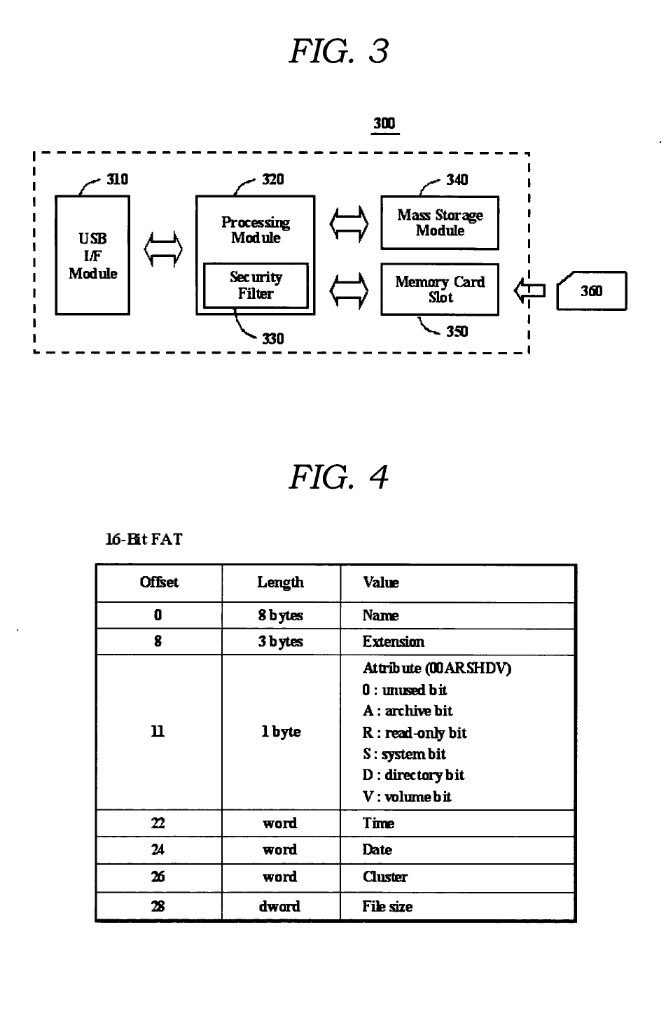

FIG. 3 is a schematic diagram showing the internal configuration of an external storage device 300 in accordance with an embodiment of the present invention. As described in this drawing, the external storage device 300 of this embodiment includes a mass storage module 340 for writing digital data, a USB interface module 310 functioning as an interface for allowing a data exchange with an external computer system, a card slot 350 for accommodating a conventional memory card 360, and a processing module 320 for controlling the other elements of the external storage module 340. Additionally, the processing module 320 includes a security filter 330 for assisting in performing the above-described security process. The mass storage module 340 is preferably formed of a non-volatile memory, such as a flash memory or hard disk, in terms of the purpose thereof.

FIG. 4 is a diagram showing a 16-bit FAT that is employed in the security process of the external storage device in accordance with an embodiment of the present invention. In the security process described above with reference to FIGS. 2A and 2B, the “file management information” corresponding to the file written in the external storage device 210 is used. In the present specification, a File Allocation Table (FAT) 400 is described as an example of such file management information. The FAT 400 shown in FIG. 4 has a 16-bit structure. FATs having more than 16-bit structures, for example, FAT having a 32-bit structure, can be appropriately constructed based upon the same concept as the FAT having the 16-bit structure. Since this is apparent to those who are skilled in the art, a detailed description of this is omitted here.

The “Cluster” field of the FAT 400 represents the physical address of a corresponding file, and can be serviceably used to refer to the physical address of the file. The some bits of the “Attribute” field of the FAT 400 can be serviceably used to indicate whether the security process of the present invention has been applied to a file written in the external storage device of the present invention. Since a 32-bit FAT has sufficient fields that can be used for such a purpose, the 32-bit FAT can be conveniently constructed to fulfill the purpose. Additionally, a method using fields other than these fields or a method using a descriptor existing within a storage medium may be freely applied to fulfill the purpose.

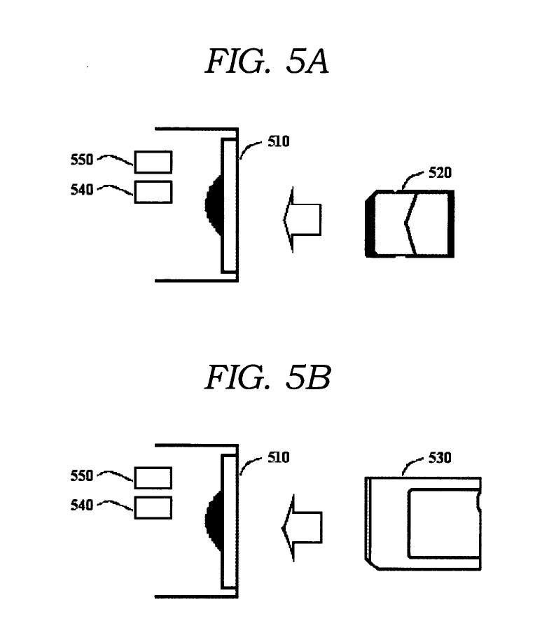

FIG. 5 is a diagram the state in which memory cards 520 and 530 of different specifications are inserted into a card slot 510 one at a time in the external storage device of the present invention. First, it is assumed that the external storage device of the present invention is provided with a space so as to accommodate memory cards of plural specifications, such as mini SD card, a MMC and a memory stick, one at a time. That is, it is assumed that, when the external storage device of the present invention is implemented and, thereafter, a memory card supported by the external storage device is inserted into the card slot 510, there is no case where the memory card cannot be used due to the limitation of the internal space of the card slot 510.

The external storage device supports memory cards of plural specifications as described above. When a memory card is inserted into the card slot, the external preferably detect the specification of the inserted memory card, that is, the specification of a mini SD card, a MMC or a memory stick. The detection function can be implemented in various ways. FIG. 5 illustrates the case where a plurality of detection terminals are disposed in the card slot 510.

The external storage device shown in FIG. 5 can accommodate a mini SD card 520 and a mini memory stick card 530. When one of them is inserted into the card slot 510, the external storage device can determines whether the inserted memory card is the mini SD card 520 or mini memory stick card 530. To this end, the external storage device is provided with a first detection terminal 540 and a second detection terminal 550. In terms of specifications, the mini SD card 520 has a small size compared with the mini memory stick 530, and a front shape different from that of the mini memory stick 530. Accordingly, when the first and second detection terminals 540 and 550 are disposed in the card slot 510, only the first detection terminal 540 is pushed when the mini SD card 520 is inserted into the card slot 510, while both the first detection terminal 540 and the second detection terminal 550 are all pushed when the mini memory stick 530 is inserted into the card slot 510. The specification of the inserted memory card can be detected by monitoring the states of the first and second detection terminals 540 and 550.

The above-described scheme is basically based upon the sizes of the first and second memory cards 520 and 530. These sizes are not limited to widths of memory cards. The detection of specifications based upon depths may be implemented in a similar manner. Meanwhile, the present invention is not limited to the above-described scheme of detecting the sizes of the memory cards using a plurality of detection terminals, but can employ other schemes. For example, it is possible to detect the sizes of the memory cards 520 and 530 by disposing a stopper in the card slot 510 and determining whether the stopper is completely pushed or the memory card 520 or 530 is caught by the stopper when the memory card 520 or 530 is inserted into the card slot 510.

In the meantime, the method of detecting the specifications of the inserted memory cards 520 and 530 in the external storage device of the present invention is not limited to the above-described schemes based upon the sizes of the memory cards 520 and 530, but may be implemented in various ways. For example, in an electrical interface between the card slot 510 and the memory cards 520 and 530, if a specific pin is capable of distinguishing the specifications of memory cards, the specific pin may be employed to detect the specifications of the inserted memory cards 520 and 530 in the external storage device. For example, if it is assumed that the state of a Pin 30 is HIGH when the mini SD card 520 is inserted into the card slot 510 while the state of the Pin 30 is LOW when the mini memory stick 530 is inserted into the card slot 510, the specifications of the memory cards 520 and 530 can be detected by monitoring the state of the Pin 30 when the memory cards 520 and 530 are inserted into the card slot 510.

Additionally, it is possible to attempt data transaction, such as file read or file write, with respect to a specific memory address and detect the specifications of the memory cards 520 and 530 based upon the result of the attempt when the memory cards 520 and 530 are inserted into the card slot 510 one at a time. For example, when the memory card 520 or 530 is inserted into the card slot 510, data transaction, such as file read or write, with respect to a specific memory address is attempted according to the specification of the mini SD card. If the inserted memory card 520 or 530 is the mini SD memory card 520, the attempt at the data transaction is successful, whereas if the inserted memory card 520 or 530 is a memory card other than the mini SD memory card 520, the attempt at the data transaction fails. If a series of attempts at data transaction are made in a similar manner, one attempt fulfills the specification of the inserted memory card and is successful, by which the specifications of the memory cards 520 and 530 can be detected.

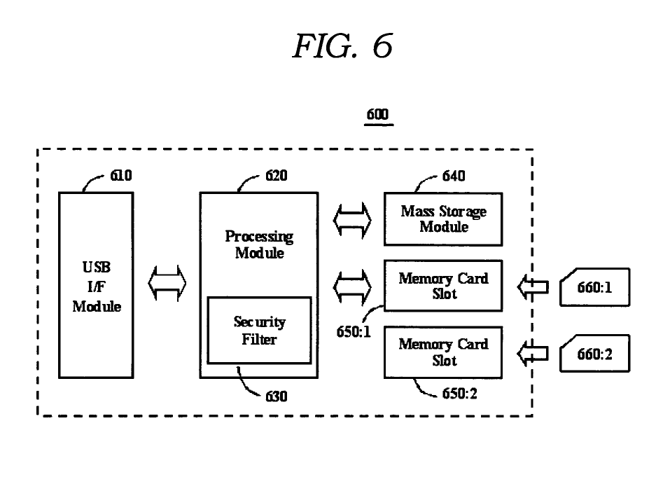

FIG. 6 is a schematic diagram showing the internal configuration of an external storage device 600 in accordance with another embodiment of the present invention. Compared with the external storage device 300 described with reference to FIG. 3, the external storage device 600 shown in FIG. 6 is characterized in that it is provided with a plurality of card slots 650:1 and 650:2. In order to make various kinds of memory cards 660:1 and 660:2 available through a signal external storage device, the plurality of card slots 650:1 and 650:2 preferably support different kinds of memory cards. However, the present invention does not exclude the case where the same card slots 650:1 and 650:2 are used in the external storage device.

In the case of FIG. 6, it is assumed that the memory card slot 650:1 supports a mini SD card and the memory card slot 650:2 supports a memory stick. Accordingly, by using the external storage device 600 shown in FIG. 6, the computer system 220 can access a mass storage module 640, a mini SD card 660:1 and a memory stick 660:2, and transmit data between the mass storage module 640 and the mini SD card 660:1, between the mass storage module 640 and the memory stick 660:2 and between the mini SD card 660:1 and the memory stick 660:2.

Since the external storage device of the present invention can use the storage medium through the card slot, the storage capacity of the external storage device is not only easily expanded but a memory card is also conveniently employed.

Further, the external storage device of the present invention performs a certain security process in the process of writing or reading files, thus appropriately protecting copyrights related to files.

In particular, although in the present specification, the memory card has been described as being the storage medium that is additionally inserted into the external storage device, it should be appreciated that the scope of the present invention is not limited to the memory card. Accordingly, it should be appreciated that the term “card slot” is not limited to a card type slot.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An external storage device, comprising:
a non-volatile storage medium for storing digital data;
a Universal Serial Bus (USB) port for providing an interface with an external apparatus; and
an expansion slot for accommodating a conventional memory module;
wherein the external storage device provides access channels complying with USB Mass Storage Class specifications so that the external apparatus accesses, through the USB port, the non-volatile storage medium and the memory module which is inserted into the expansion slot;
wherein, when the external storage device receives a medium access command from the external apparatus through the USB port, the external storage device interprets the medium access command to determine whether the medium access command is for accessing the non-volatile storage medium or for accessing the memory module inserted into the expansion slot, and provides an media access service corresponding to the medium access command.

2. The external storage device as set forth in claim 1, wherein the expansion slot is formed to be open to one side, and wherein the USB port is formed to be directing the other side.

3. An external storage device, comprising:
a non-volatile storage medium for storing digital data; and
a digital interface port for providing an interface with an external apparatus;
wherein the external storage device provides an access channel so that the external apparatus accesses the non-volatile storage medium through the digital interface port according to a certain medium access protocol;
wherein, when the external storage device receives a file write command from the external apparatus according to the medium access protocol, the external storage device performs a secure file write process, the secure file write process comprising the first step of allocating a space to a file and writing the file on the allocated space and the second step of setting a value of file management information to a second value different from a first value corresponding to information of a physical location where the file is actually written, the second value being obtained by applying a certain rule to the first value.

4. The external storage device as set forth in claim 3, wherein the external storage device further comprises an expansion slot for accommodating a conventional memory module, and provides an access channel so that the external apparatus accesses the memory module, inserted into the expansion slot, through the digital interface port according to a certain medium access protocol, and the secure file write process further comprises the step of determining whether the medium access command aims to access the non-volatile storage medium or the memory module inserted into the expansion slot by interpreting the medium access command, before the first step.

5. The external storage device as set forth in claim 3, wherein, when the external storage device receives the file write command from the external apparatus according to the medium access protocol, the external storage device determines whether the file requires a security process before performing the secure file write process, performs the secure file write process if the file requires the security process, and performs a conventional file write process if the file does not require the security process.

6. The external storage device as set forth in claim 3, wherein the secure file write process further comprises the third step of setting a value of second file management information corresponding to the written file to a certain value indicating that the written file is written by the secure file write process, the second step and the third step being performed regardless of order.

7. An external storage device, comprising:
a non-volatile storage medium for storing digital data; and
a digital interface port for providing an interface with an external apparatus;
wherein the external storage device provides an access channel so that the external apparatus accesses the non-volatile storage medium through the digital interface port according to a certain medium access protocol;
wherein, when the external storage device receives a file read command from the external apparatus according to the medium access protocol, the external storage device performs a secure file read process, the secure file read process comprising the first step of obtaining physical information of the file from file management information corresponding to the file and the second step of obtaining data from a second location of the non-volatile storage medium different from a first location of the non-volatile storage medium corresponding to the physical information and transmitting the data through the digital interface port, the second location being obtained by applying a certain rule to the first location.

8. The external storage device as set forth in claim 3, wherein the management information is constructed to include a cluster field of a File Allocation Table (FAT), and the certain rule is represented as a function F, the function F being selected to allow an inverse function F⁻¹ to exist.

9. The external storage device as set forth in claim 7, wherein, when the external storage device receives the file read command from the external apparatus according to the medium access protocol, the external storage device determines whether the file requires a security process before performing the secure file read process, performs the secure file read process if the file requires the security process, and performs a conventional file read process if the file does not require the security process.

10. The external storage device as set forth in claim 1, wherein the expansion slot has an internal space constructed to accommodate memory modules of plural specifications one at a time, and the external storage device detects a specification of a memory module based upon a size of the memory module when the memory module is inserted into the expansion slot.

11. The external storage device as set forth in claim 10, wherein the external storage device is provided with a plurality of detection terminals in an end of the expansion slot, and detects the size of the memory module based upon states of the detection terminals when the memory module is inserted into the expansion slot.

12. The external storage device as set forth in claim 10, wherein the external storage device is provided with a plurality of detection terminals in a side of the expansion slot, and detects the size of the memory module based upon states of the detection terminals when the memory module is inserted into the expansion slot.

13. The external storage device as set forth in claim 1, wherein the expansion slot has an internal space constructed to accommodate memory modules of plural specifications one at a time, and the external storage device detects a specification of a memory module based upon a state of a pin positioned at a certain location on an electrical interface between the expansion slot and the memory module when the memory module is inserted into the expansion slot.

14. The external storage device as set forth in claim 1, wherein the expansion slot has an internal space constructed to accommodate memory modules of plural specifications one at a time, and the external storage device attempts data transaction with respect to a memory module and detects a specification of the memory module based upon a result of the attempt when the memory module is inserted into the expansion slot.

15. The external storage device as set forth in claim 1, wherein the expansion slot is constructed to have a plurality of sub-slots, each of the sub-slots has an opening for accommodating a conventional memory module, the external storage device provides an access channel complying with the medium access protocol so that the external apparatus accesses the memory module, inserted into the sub-slot, through the digital interface port, and allows data to be transmitted between the non-volatile storage medium and memory modules inserted into the plurality of sub-slots and between the memory modules inserted into the plurality of sub-slots.

16. The external storage device as set forth in claim 4, wherein, when the external storage device receives the file write command from the external apparatus according to the medium access protocol, the external storage device determines whether the file requires a security process before performing the secure file write process, performs the secure file write process if the file requires the security process, and performs a conventional file write process if the file does not require the security process.

17. The external storage device as set forth in claim 4, wherein the secure file write process further comprises the third step of setting a value of second file management information corresponding to the written file to a certain value indicating that the written file is written by the secure file write process, the second step and the third step being performed regardless of order.

18. The external storage device as set forth in claim 7, wherein the management information is constructed to include a cluster field of a File Allocation Table (FAT), and the certain rule is represented as a function F, the function F being selected to allow an inverse function F⁻¹ to exist.

19. The external storage device as set forth in claim 4, wherein the expansion slot has an internal space constructed to accommodate memory modules of plural specifications one at a time, and the external storage device detects a specification of a memory module based upon a size of the memory module when the memory module is inserted into the expansion slot.

20. The external storage device as set forth in claim 19, wherein the external storage device is provided with a plurality of detection terminals in an end of the expansion slot, and detects the size of the memory module based upon states of the detection terminals when the memory module is inserted into the expansion slot.

21. The external storage device as set forth in claim 19, wherein the external storage device is provided with a plurality of detection terminals in a side of the expansion slot, and detects the size of the memory module based upon states of the detection terminals when the memory module is inserted into the expansion slot.

22. The external storage device as set forth in claim 4, wherein the expansion slot has an internal space constructed to accommodate memory modules of plural specifications one at a time, and the external storage device detects a specification of a memory module based upon a state of a pin positioned at a certain location on an electrical interface between the expansion slot and the memory module when the memory module is inserted into the expansion slot.

23. The external storage device as set forth in claim 4, wherein the expansion slot has an internal space constructed to accommodate memory modules of plural specifications one at a time, and the external storage device attempts data transaction with respect to a memory module and detects a specification of the memory module based upon a result of the attempt when the memory module is inserted into the expansion slot.

24. The external storage device as set forth in claim 4, wherein the expansion slot is constructed to have a plurality of sub-slots, each of the sub-slots has an opening for accommodating a conventional memory module, the external storage device provides an access channel complying with the medium access protocol so that the external apparatus accesses the memory module, inserted into the sub-slot, through the digital interface port, and allows data to be transmitted between the non-volatile storage medium and memory modules inserted into the plurality of sub-slots and between the memory modules inserted into the plurality of sub-slots.
